(19) United States
(12) Patent Application Publication
(10) Pub. No.: US 2024/0078446 A1
(43) Pub. Date: Mar. 7, 2024

(54) AUTOMATICALLY GENERATING DESCRIPTIONS FOR CLASSIFICATION RESULTS

(71) Applicant: Theorem Partners LLC, San Mateo, CA (US)

(72) Inventors: Jonathan Lloyd BLACKMAN, Redwood City, CA (US); Mark Andrew ELLIOT, New York, NY (US)

(73) Assignee: Theorem Partners LLC, San Mateo, CA (US)

(21) Appl. No.: 18/456,199

(22) Filed: Aug. 25, 2023

Related U.S. Application Data
(60) Provisional application No. 63/403,141, filed on Sep. 1, 2022.

(51) Int. Cl. G06N 5/022

(52) U.S. Cl. CPC G06N 5/022

(57) ABSTRACT

A method for generating descriptions of classification results, comprising classifying original inputs in a data set using a classifier. For one or more of the plurality of original inputs, apply an adjustment to one or more features of the original input to produce a respective adjusted input, and classify the respective adjusted input using the classifier. For one or more of the adjusted inputs, record a corresponding original input into a training set, and record information associated with the adjusted input into the training set. The method further comprises training a model based on the training set, such that the model is configured to receive an original model input and identify a hypothetical adjustment that would produce an adjusted model input that would be assigned an adjusted model classification with a different class than a class assigned to the original model input.

### CROSS-REFERENCE TO RELATED APPLICATIONS

This application claims the benefit of U.S. Provisional Application No. 63/403,141, filed Sep. 1, 2022, the entire contents of which are incorporated herein by reference.

### FIELD

This disclosure generally relates to models for data classification, and more specifically to automatically generating descriptions for classification results.

### BACKGROUND

Classification models are data-processing models that classify inputs into one or more of a plurality of classifications. Classification models are often trained using machine learning methods, including deep-learning methods, to improve performance of the model. A variety of automated methods are known for assessing the speed and accuracy of the performance of classification models.

### SUMMARY

While automated methods exist for assessing the accuracy and speed of classification models, it remains comparatively more challenging to analyze and quantify how classification models generate the output (e.g., the classifications) that they do. Known methods for assessing classification models offer little or no visibility into what features of input data are most important in causing a given input to be classified in a certain way, and offer little or no visibility into what features of input data, if changed, would change the result of the classification. Certain manual approaches have been tried in order to obtain an understanding of classification models. Some of these manual approaches involve classifying a set of inputs, plotting the distributions of domain-expert-selected input features against the classification results, and then hand-selecting thresholds for uni-modal or bi-modal distributions. While such approaches can offer a limited understanding into the operation of simple classification models (e.g., random trees, random forests, and regressions), these approaches are infeasible for use with complex classification models such as neural networks and/or deep-learning-based model architectures. Accordingly, there is a need for improved systems and methods for quantifying, explaining, and/or otherwise describing performance of classification models. Disclosed herein are systems and methods that may address the above-identified need.

Disclosed herein are systems and method for automatically generating descriptions (including, e.g., quantifications, explanations, etc.) for classification results. According to the techniques described herein, a classification model may be used to generate respective classification results for a set of inputs. Some subset of the set of inputs (for example, those inputs that generated a classification result into one or more predefined classifications) may then be adjusted to generate adjusted inputs. The classification model may then be used to generate respective updated classification results for the subset of adjusted inputs. A training data set may then be stored, wherein the training data set comprises (at least some of) the original inputs that were selected for adjustment, the adjusted inputs, and the updated classification results for the adjusted inputs. A machine-learning model may then be trained using the training data set, wherein the machine-learning model is trained to generate, based on an input, output data indicating an adjustment that, if applied to one or more features of the input, would cause the classification model to generate a different result than if the adjustment were not applied.

The trained machine-learning model may then be used to automatically identify potential adjustments for inputs, and thus to automatically generate descriptions for the classification results generated by the classifier. The systems and methods described herein may thus be used to identify specific adjustments for an input that would change a classification result for the input, thereby offering explanation and visibility into the performance of the classification model and offering actionable adjustments that may be applied to the original data if a different output result is desired.

In various embodiments, a method for generating descriptions of classification results includes receiving a data set; and classifying a plurality of original inputs in the data set using a classifier, such that each of the plurality of original inputs is assigned a respective first classification. For one or more of the plurality of original inputs, the method further includes applying an adjustment to one or more features of the original input to produce a respective adjusted input; and classifying the respective adjusted input using the classifier, such that the respective adjusted input is assigned a respective second classification. For one or more of the adjusted inputs, the method further includes: recording a corresponding original input into a training set; and recording information associated with the adjusted input into the training set, wherein the information indicates the adjustment to produce the adjusted input. In various embodiments, the method further includes training a model based on the training set, such that the model is configured to receive an original model input and identify a hypothetical adjustment that, if applied to the original model input, would produce an adjusted model input, wherein the adjusted model input would be assigned an adjusted model classification that indicates a different class than a class indicated by an original model classification assigned to the original model input.

Optionally, the information associated with the adjusted input includes the one or more features for the adjusted input that were adjusted and one or more adjustment amounts that were applied to the one or more features. Optionally, the respective second classification of the one or more of the adjusted inputs indicates a different class than an original class indicated by the respective first classification for the corresponding original input. Optionally, the model is configured to receive the original model input and output the hypothetical adjustment. Optionally, the model is configured to receive the original model input and the hypothetical adjustment, and output an indication as to whether the hypothetical adjustment would produce the adjusted model input. Optionally, the hypothetical adjustment comprises one or more features of the original model input and one or more adjustment amounts for the one or more features of the original model input. Optionally, the method further includes applying a second adjustment to the one or more features of the original input to produce a second adjusted input corresponding to the original input. Optionally, the method further includes selecting the one or more features that are adjusted based on a user input. Optionally, the method further includes selecting the one or more features that are adjusted based on a dimensionality reduction operation. Optionally, the one or more features for one of the original inputs that are adjusted are different than the one or more features that are adjusted for at least one of the other original inputs. Optionally, the method further includes determining adjustment amounts for one or more of the adjusted features based on a user input. Optionally, the method further includes determining an adjustment amount for the adjustment to the one or more features for the original input based on a statistical characteristic of values for the feature in the original inputs in the data set.

In various embodiments, one or more computer-readable non-transitory storage media embodying software for generating descriptions of classification results, the software comprising instructions operable when executed by a computing system to receive a data set; and classify a plurality of original inputs in the data set using a classifier, such that each of the plurality of original inputs is assigned a respective first classification. For one or more of the plurality of original inputs, the instructions are further operable when executed to apply an adjustment to one or more features of the original input to produce a respective adjusted input; and classify the respective adjusted input using the classifier, such that the respective adjusted input is assigned a respective second classification. For one or more of the adjusted inputs, the instructions are further operable when executed to: record a corresponding original input into a training set; and record information associated with the adjusted input into the training set, wherein the information indicates the adjustment to produce the adjusted input. In various embodiments, the instructions are further operable when executed to train a model based on the training set, such that the model is configured to receive an original model input and identify a hypothetical adjustment that, if applied to the original model input, would produce an adjusted model input, wherein the adjusted model input would be assigned an adjusted model classification that indicates a different class than a class indicated by an original model classification assigned to the original model input.

In various embodiments, a system for generating descriptions of classification results, the system comprising one or more processors and a memory coupled to the processors comprising instructions executable by the processors, the processors being operable when executing the instructions to cause the system to receive a data set; and classify a plurality of original inputs in the data set using a classifier, such that each of the plurality of original inputs is assigned a respective first classification. For one or more of the plurality of original inputs, the processors are further operable when executing the instructions to apply an adjustment to one or more features of the original input to produce a respective adjusted input; and classify the respective adjusted input using the classifier, such that the respective adjusted input is assigned a respective second classification. For one or more of the adjusted inputs, the processors are further operable when executing the instructions to: record a corresponding original input into a training set; and record information associated with the adjusted input into the training set, wherein the information indicates the adjustment to produce the adjusted input. In various embodiments, the processors are further operable when executing the instructions to train a model based on the training set, such that the model is configured to receive an original model input and identify a hypothetical adjustment that, if applied to the original model input, would produce an adjusted model input, wherein the adjusted model input would be assigned an adjusted model classification that indicates a different class than a class indicated by an original model classification assigned to the original model input.

Any one or more of the embodiments and/or aspects described above may be combined, in whole or in part, with one another and/or with any other disclosure herein.

### BRIEF DESCRIPTION OF THE FIGURES

FIG. 1 illustrates a method for automatically generating descriptions for classification results according to examples of the disclosure.

FIG. 2 illustrates a system for automatically generating descriptions for classification results according to examples of the disclosure.

FIG. 3 illustrates an example training set of inputs and the adjustments that were made to the inputs.

FIG. 4 illustrates an example application of generating descriptions for classification results according to an example of the disclosure.

FIG. 5 illustrates an example computer system according to examples of the disclosure.

### DETAILED DESCRIPTION

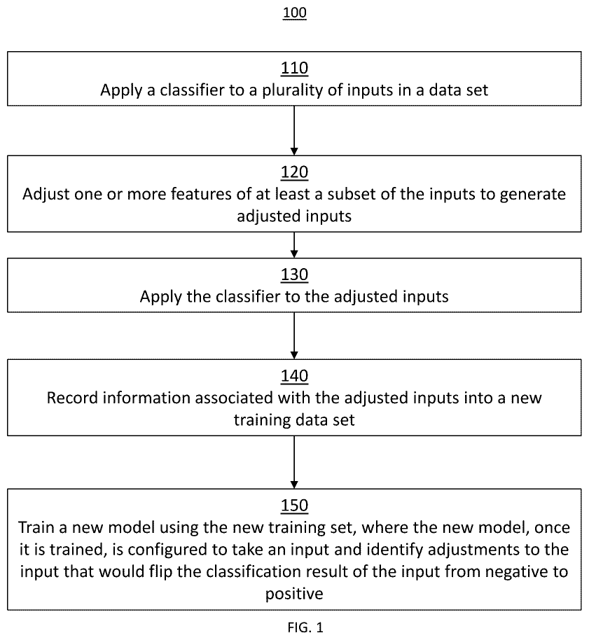

FIG. 1 illustrates a flowchart of an example method 100 for automatically generating descriptions for classification results. The classification results may be assigned by a binary classifier that is configured to assign one of two possible classifications to any given input. While the present disclosure may describe the method 100 with respect to a binary classifier, the method may be extended to apply to multi-class classifiers as well. This may be possible through any technique known in the art, such as One-vs-Rest or One-vs-One that may reduce multi-class classifications to a collection of binary classifications. More specifically, the One-vs-Rest strategy may reduce a multi-class classification to one binary classification per original class, while the One-vs-One strategy may reduce a multi-class classification to one binary classification problem per each pair of original classes. Consequently, the method 100 may be applicable to multi-class classifications by running more than one instance of the method.

The descriptions for the classification results in the context of the present disclosure may be defined as adjustments that may be made to inputs that may flip the assigned classification of the inputs. More specifically, the adjustments for an input may identify what would need to be changed about the input in order for its classification to change to the other of the two possible classifications. The adjustments for an input may be considered the description for an input's classification as it may explain why the input's assigned classification was not the other classification. By identifying adjustments that may be made to flip an input's classification, the complement of the identified adjustment may be understood to mean why it was assigned its classification. Accordingly, as a generic example, if an adjustment of +a, or an adjustment comprising an increase of an amount a, is identified that may cause an input's classification to flip, that adjustment may mean that some aspect of the input is a units too low in order to be assigned the other classification, and thus that is why it was assigned its classification. Consequently, the method 100 may describe how such adjustments, or descriptions, may be automatically generated.

At step 110 of method 100, a classifier may be applied to an original input data set in order to assign a classification to each input in the data set. The classifier may be a binary classifier or a classifier that assigns inputs to one (or more) or any suitable number of classifications. In some examples, the classifier may assign each input either a positive or negative classification.

In some examples, method 100 may be applied to automatically generated descriptions for inputs that are assigned a negative classification result that is referred to as negative; however, the method 100 may apply symmetrically to automatically generating descriptions for classifications results that may be referred to as “positive” as well. In some examples, method 100 may be applied simultaneously to classification results that are classified into different classifications, which may for example enable generating descriptions for classification results that are positive and negative (or that are associated with any suitable label).

At step 120, the method 100 may adjust one or more features of at least a subset of the inputs in the data set from step 110, in order to thereby generate a set of adjusted inputs.

In some examples, a subset of the data set from step 110 may be selected for adjustment based on the classification results of step 110. The letter D may be used herein for brevity to denote the data set comprising the original un-adjusted inputs that were assigned classifications in step 110, while D′ may be used herein to denote a data set comprising the adjusted inputs that are produced as a result of the feature adjustments to the inputs in D as part of step 120. Each adjusted input d′∈D′ may have a corresponding original input d∈D from which the d′ adjusted input was produced. The original inputs in D may, for example, be three-dimensional with features x, y, and z, where x, y, and z may be any type of value (e.g. integer, real, whole, etc.). However, it may be noted this is a completely arbitrary designation and is only meant to serve as a continuing example to describe the steps in method 100. Adjusting one or more of the x, y, and z features as part of step 120 may produce adjusted inputs with one or more adjusted features x′, y′, and z′, corresponding respectively to x, y, and z.

In step 120, the features for any original input d₁∈D that are adjusted may be different than the features that are adjusted in some other original input d₂∈D. In other words, step 120 may produce adjusted inputs in set D′ wherein the adjusted inputs may have different features that were adjusted. More specifically, it may be the case that a first adjusted input d₁′∈D′ includes only an adjusted x′ feature, while another adjusted input d₂′∈D′ includes adjusted x′ and y′ features. This approach may be advantageous in cases where it may be difficult to determine which features are most worth adjusting to find adjustments that may flip the classification of an original input. As a result, step 120 may produce a set D′ with adjusted inputs that have a non-uniform set of adjusted features.

Alternatively or additionally in step 120, adjusting the features may comprise adjusting more than one distinct combination of features for original inputs in D. For example, step 120 may comprise adjusting a first combination of features that include only the x feature, another combination that includes only the y feature, and a third combination that includes the x and y features. As a result, the multiple combinations of feature adjustments for any one original input d∈D may produce multiple corresponding adjusted inputs d′∈D′. More specifically, the first combination of feature adjustments that includes only the x feature of d may produce a first adjusted input dₐ′, where if the original input d may be described as the set of features {x, y, z}, then dₐ′ may be described as the set of features {x′, y, z} that result from the adjustments in the first combination of feature adjustments. The second combination of feature adjustments that includes only the y feature of d may produce a second adjusted input d_{b}′, where d_{b}′ may be described as the set of features {x, y′, z} that result from the adjustments in the second combination of feature adjustments. Similarly, the third combination of feature adjustments that includes the x and y features of d may produce a third adjusted input d_{c}′, where d_{c}′ may be described as the set of features {x′, y′, z} that result from the adjustments in the third combination of feature adjustments. By adjusting multiple combinations of features for any original input d∈D, step 120 may produce multiple corresponding adjusted inputs d′∈D′, such as in the example above where the three combinations of feature adjustments resulted in three adjusted inputs dₐ′, d_{b}′, d_{c}∈D′ being produced for the one original input d∈D. It may be noted that there may be many combinations of feature adjustments that may be possible in various examples of the present disclosure, but because the number of possible combinations may increase exponentially in relation to the number of features in an input, it may be necessary to balance the computational burden of pursuing a large number of combinations with the potential advantages of pursuing a large number of combinations.

In part due to the trade-offs described above regarding the computational burdens of adjusting features of inputs in a large number of possible combinations, the system may in some examples select a subset of inputs, features thereof, and/or combinations of features thereof to adjust. In some examples, inputs that generated a predefined classification results at step 110 may be selected for adjustment at step 120. For example, in some examples, all inputs that generated a negative classification result may be selected for adjustment. In some examples, all inputs that generated a positive classification result may be selected for adjustment. In some examples, all inputs that generated any suitable predetermined and/or dynamically-selected classification result may be selected for adjustment. In some examples, a subset of classification results may be selected for adjustment based on a user input that indicates the subset of the classification results.

Inputs and/or features thereof selected for adjustment as part of step 120 may be determined in any number of ways in various examples of the present disclosure. In some examples, inputs and/or features thereof may be selected according to one or more predefined rules. For example, such an approach may comprise preselecting feature x to be the feature to adjust, and thus step 120 may comprise adjusting feature x of original inputs in D to produce adjusted inputs with feature x′ in D′. Although this may be feasible in examples where the number of features is small and it is somewhat clear how an input's features affect the classification that is assigned to the input, such an approach may be less effective in other examples where the number of features may be rather large. Another approach may comprise randomly or quasi-randomly selecting the features to adjust. While this approach may be applicable regardless of the feature space, the approach may suffer from being unable to reliably identify the most pertinent features affecting the classification assigned to an input.

In some examples, inputs and/or features thereof selected for adjustment as part of step 120 may be selected by leveraging one or more dimensionality reduction techniques. Such dimensionality reduction techniques may include various feature selection approaches, such as but not limited to: filter strategy approaches such as information gain and chi-square test, wrapper strategy approaches such as forward feature selection and backward feature selection, and embedded strategy approaches such as LASSO regularization and random forest importance. Additionally, feature projection approaches such as principal component analysis (PCA) may also be leveraged in order to help identify which features may be most pertinent to the classification that is assigned to an input and thus most worthy of exploring adjustments for. However, step 120 may be satisfied as long as adjustments are made to some of the features of the original inputs in the data set D, and regardless of the exact features that are adjusted and how those features are selected.

In addition to determining which features are adjusted as part of step 120, the magnitude of those adjustments (e.g., an amount by which to adjust a feature that is adjusted) may also be determined in any number of ways in various examples of the present disclosure. One approach may be to manually preselect the adjustment amount for the features (for example based on one or more rules). In some examples, adjustment amounts may be adjusted in subsequent iterations of method 100. However, like manually preselecting which features to adjust in step 120, such an approach may suffer from requiring preexisting knowledge in order to identify appropriate adjustment amounts for the features. Another approach may be to randomly or quasi-randomly select the adjustment amounts (e.g., by selecting a percentage adjustment according to a randomization operation and/or by selecting a direction in which to adjust the feature in accordance with a randomization operation). While random selection of adjustment amounts may eventually yield effective results, an approach that leverages information about the data set and/or the classification model in order to select adjustment amounts may more quickly converge on effective results. For example, adjustment amounts may be selected based on the distribution of the values for the corresponding features in the original inputs with a positive classification. For example, if the feature x has been selected to be the feature to be adjusted, and the feature x in the original inputs with a positive classification have values in a normal distribution centered on some value v, a target value vₜ may be selected from that normal distribution, and the adjustment amount for feature x in original inputs with a negative classification may be determined based on what is needed to reach vₜ. This approach may offer an empirical way of determining adjustment amounts while also remaining practical for various examples of the present disclosure.

In some examples, adjustments may be selected based on a predefined and/or user selected adjustment algorithm. An adjustment algorithm may generate adjusted values that comport with a specified distribution, center-value, variance, standard deviation, or any other specified statistical criteria. The system or user may designate target criteria for the adjusted values, and/or may designate an extent to which one or more adjusted values (or adjusted value sets) should or should not deviate from values in the original data set.

At step 130, the classifier that was used to assign classifications in step 110 may be used again to assign classifications to the adjusted inputs in D′ that are produced as a result of step 120. While each of the adjusted inputs in D′ may correspond to an original un-adjusted input in D, the adjusted inputs in D′ may be assigned their own respective classifications separate from the classifications assigned to their corresponding original inputs in D. It may be the case that some of the adjusted inputs in D′ are assigned the same classifications as their corresponding original inputs in D, while other adjusted inputs in D′ may be assigned different classifications from their corresponding original inputs in D. Thus, some of the adjustments that were made to the original inputs in D as part of step 120 may thus produce adjusted inputs with “flipped” classifications. The adjustments that produced those adjusted inputs thus may be understood to represent adjustments that may be made to the corresponding original inputs in D to “flip” the classification that was assigned to the original inputs. Such adjustments may thus be understood as descriptions (e.g., explanations), or may be used to generate descriptions, as to why those original inputs were assigned their original classifications.

At step 140, various information associated with the adjusted inputs in D′ may be recorded in a training data set, such that the training data set may be used to train a machine learning model to generate output data representing adjustments that would be expected to flip the classification result of input data classified by the classification model applied at step 110.

In some examples, the adjusted inputs D′ along with their corresponding classification results generated at step 130 may be recorded in the training data set. In some examples, only a subset of the adjusted inputs and associated classification results may be recorded in the training data set. In some examples, only those adjusted inputs that resulted in a “flipped” classification may be recorded in the training data set.

In some examples, additional information associated with the adjusted inputs that are recorded in the training data set may also be recorded in the training data set. For example, adjusted inputs may be recorded in the training data set along with their adjusted classification results, their corresponding original inputs in D, their corresponding original classification results, an indication as to their adjusted feature(s), and/or an indication as to a magnitude of their adjusted feature(s). Since the adjustments that were made to the recorded adjusted inputs may be interpreted as a description (e.g., an explanation) for the original associated classification result assigned to the original associated inputs in D, recording information on the adjustments along with the corresponding original inputs into the training set for the model may enable the model to learn to automatically identify adjustments for original inputs that are expected to “flip” the assigned classification.

The information recorded into the new training set may include which features of the original inputs of D were adjusted in step 120 and the amounts by which those features were adjusted. Other information may also be recorded in the training data set, such as metadata regarding a manner in which the inputs were selected for adjustment, a manner in which the features were selected for adjustment, and/or a manner in which adjustment amounts were selected.

In some examples, the training set may also include original inputs and corresponding adjustments made to them in step 120 even if those adjustments did not produce adjusted inputs with a flipped classification result. In some examples, the training data set may be stored with labels indicating whether an adjusted input resulted in a flipped classification result.

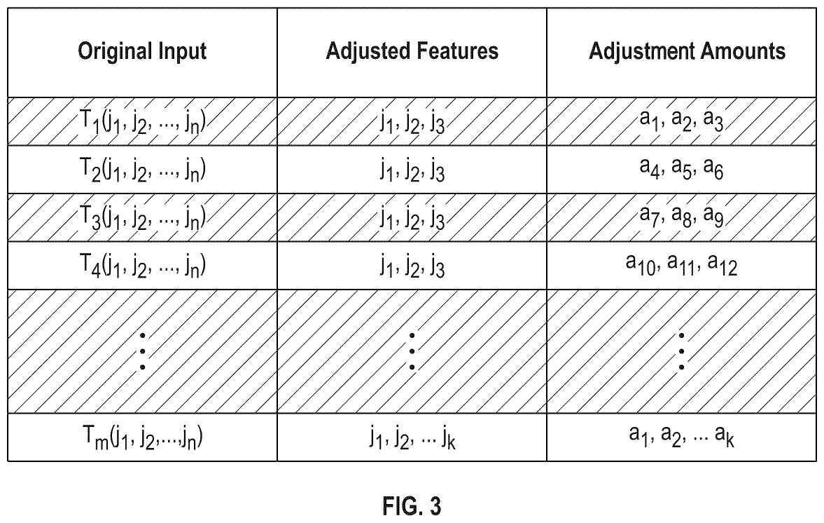

FIG. 3 depicts a table that illustrates an example training set and the contents that may be recorded in the training set. The training set may comprise a plurality of original inputs T₁ to Tₘ, where each original input may comprise n features from j₁ up to jₙ. For each of the original inputs, the training set may indicate the feature or features that were adjusted for the original inputs during step 120. In the specific example training set of FIG. 3, feature j₁, j₂, and j₃ may have been adjusted for each original input. More generally, the training set may record that features j₁, j₂, up to jₖ were adjusted for an original input Tₘ. In other words, any k features for an original input Tₘ may have been adjusted, where k≤n. The training set may further include the adjustment amounts for the adjusted features. In the example training set of FIG. 3, feature j₁ of original input T₁ may have been adjusted by an amount a₁, feature j₂ of original input T₁ may have been adjusted by an amount a₂, and feature j₃ of original input T₁ may have been adjusted by an amount a₃. Additionally, features j₁, j₂, and j₃ of the other original inputs may have been adjusted by various other amounts a₄-a₁₂. It may be noted that each of the specific values for each of the adjustment amounts may be positive or negative, where a positive amount may indicate that the original value for the feature was increased by the adjustment amount while a negative adjustment amount may indicate that the original value for the feature was decreased by the adjustment amount. More specifically, in the example in FIG. 3, a₁ being positive may indicate that the original value for feature j₁ of original input T₁ was increased by a₁ to produce a corresponding adjusted input, whereas a₁ being negative may indicate that the original value for feature j₁ of original input T₁ was decreased by a₁ to produce the corresponding adjusted input. More generally, the training set may record adjustment amounts a₁, a₂, up to aₖ, corresponding to features j₁, j₂, up to jₖ to denote that feature j₁ was adjusted by an amount a₁, feature j₂ was adjusted by an amount a₂, and so on, up to feature jₖ being adjusted by an amount aₖ.

Additionally, the specific structure of the training set may be flexible, as it may depend on the type of model that the training set may be used to train in the subsequent step. More specifically, the sections of the training set that may be denoted as the model input and/or the model output may be flexible and may depend on the type of model being trained. For example, some models may be designed to accept input that indicates an original input, adjusted feature(s), and adjustment amounts, and the model may generate an output that indicates whether the input adjusted feature(s) and adjustment amount(s) for the original input would result in a flipped classification. On the other hand, some models may be designed to accept input that designates only an original input, and the model's output may include an indication of one or more features and/or one or more adjustment amounts that would result in a flipped classification.

At step 150, the training set may be used to train a model that identifies adjustments for flipping the classification of an original input in D. In some examples, the model that is trained may be able to identify adjustments that may be made to some of the features of an original input which was assigned a negative classification that would produce a corresponding adjusted input with a positive classification.

As indicated earlier, many different kinds of models may be trained at this step. For example, one possible model may resemble a classifier type model which may be trained on a training set where the model's inputs comprise an original input from D, a set of features, and adjustment amounts for those features; while the model's output comprises a label for each model input that may include a yes/no or true/false for whether the combination in the model input may produce an adjusted input with a positive classification. In some examples, the model may accept as input an indication of a data input and an adjustment (e.g., indicating a feature and/or an amount to be adjusted), and the model may generate as output an indication as to whether the indicated adjustment would generate a flipped classification result for the classifier. Such a model may be trained as part of step 150 to identify whether a given set of features for a negatively classified original input and adjustment amounts for those features would produce an adjusted input with a positive classification. Such a model may also be configured to identify the adjustments that would not flip the original input's classification.

Another possible model may resemble a predictor type model which may be trained on a training set where the model's input only comprises a data input and the model's output may include a combination of features and adjustment amounts for those features that would produce an adjusted input with a positive classification. In some examples, the model may accept as input an indication of a data input, and may generate as output an indication of one or more adjustments (e.g., indicating a feature and/or an amount to be adjusted) that would be expected to yield an adjusted data input that would generate a flipped classification result for the classifier. Such a model may be trained to predict the features and adjustment amounts for those features when provided a negatively classified original input such that the combination of features and adjustment amounts, when applied to the provided original input, would produce an adjusted input with a positive classification.

Although two model architectures are considered herein, many other architectures may be appropriate, and any architecture that enables the model to identify adjustments for a data input may be trained at step 150.

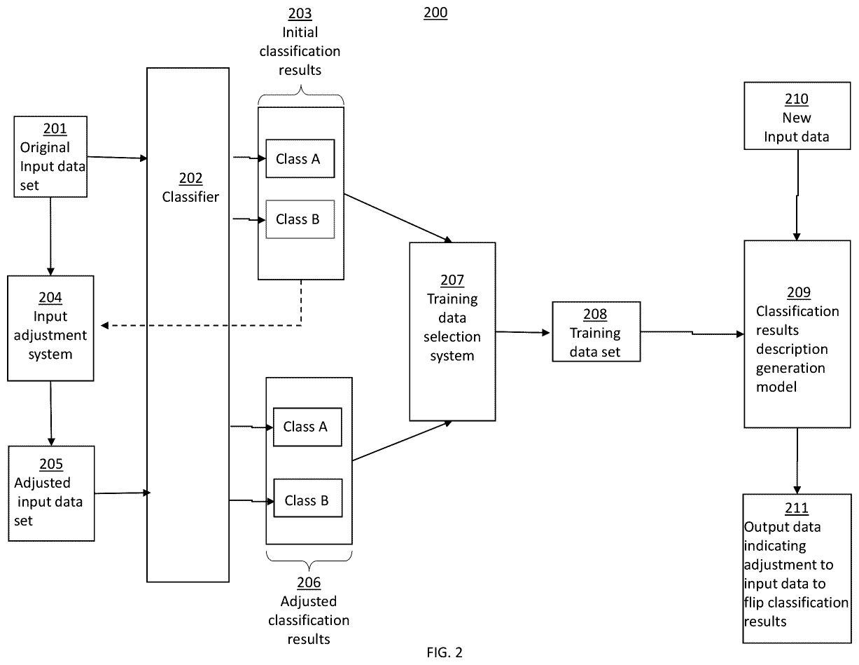

FIG. 2 illustrates a schematic diagram of a system 200 for automatically generating descriptions for classification results. In some examples of the present disclosure, system 200 may correspond with method 100, where the components and interactions between components in system 200 may be reflective of the steps in method 100.

System 200 may receive an original input data set 201 that is provided to a classifier system 202, which may comprise a binary classifier. The classifier system 202 may be configured to assign one of two classes, Class A and Class B, to the inputs in the data set 201 in order to produce a set of initial classification results 203, where Class A and Class B may correspond to the positive and negative classifications assigned by the classifier according to the description of method 100 above. In some examples of the present disclosure, the original data set 201, the classifier system 202, and the initial classification results 203 may correspond to step 110 of method 100.

System 200 may further comprise an input adjustment system 204 that receives inputs from the original input data set 201. The input adjustment system 204 may make adjustments to features of the original inputs from data set 201 in order to produce a set of adjusted input data 205. Input adjustment system 204 may also receive input from initial classification results 203, and for example may select which inputs in original input data set 201 should be adjusted based on the classification outcomes indicated in classification results 203. The resulting set of adjusted input data 205 may then be provided to the classifier system 202. In a similar manner as with original input set 201, classifier system 202 may assign one of two classes, Class A and Class B, to the adjusted inputs in the data set 205 in order to produce a set of adjusted classification results 206. In some examples of the present disclosure, the input adjustment system 204, the adjusted input data set 205, and the adjusted classification results 206 may correspond to step 120 and step 130 of method 100.

System 200 may further comprise training data selection system 207 that may be configured to generate a training data set 208 for training a model 209 for generating descriptions for the classification results produced by classifier system 202. Training data selection system 207 may receive as input initial classification results 203 and adjusted classification results 206, and may select a subset of said received data for inclusion in training data set 208. For example, selection system 207 may identify instances where the initial classification result differs from the adjusted classification result, as those instances may indicate when adjustments made by the input adjustment system 204 resulted in flipped classification results, and may help to train a model to automatically identify such adjustments, as described above in regards to method 100. Consequently, in some examples of the present disclosure, the training data selection system 207 and the training data set 208 that may be generated from the selection system may correspond to step 140 of method 100. Additionally, in some examples of system 200, the training data selection system 207 may also take input from one or both of the original input data set 201 and adjusted input data set 205 in order to generate the training data set 208, and training data set 208 may include original data and/or adjusted data in addition to corresponding classification results.

System 200 may further comprise a classification results description generation model system 209, which may include a model trained using the training data set 208. Description generation model system 209 may include a model trained to automatically identify adjustments that may be made to inputs that may flip the classification assigned to those inputs by the classifier system 202. The description generation model 209 may be configured to take as input data 210 and identify as output data indicating adjustments for the input data that may flip its classification result 211. As mentioned above, the output indicating adjustments 211 for an input may provide a description/explanation for the input's classification. Thus, in some examples of the present disclosure, description generation model system 209 and training data set 208 used to train a model applied by system 209 may correspond to step 150 of method 100.

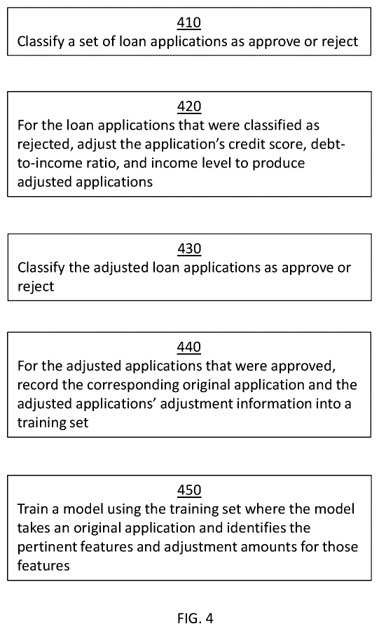

FIG. 4 illustrates the steps of an example application of method 100, particularly in the context of loan applications. At step 410, a classifier, such as the classifier system 202, may assign a binary classification to a set of loan applications, which may correspond to data set 201, on whether to approve or reject the application for a loan. In this case, applications that are assigned an approval classification may be the positive classifications and applications that are assigned a rejection classification may be the negative classifications. At this point, the applications that are classified as approved may be forwarded elsewhere to start the process of granting the loan.

At step 420, the credit score, debt-to-income ratio, and income level of the applicant in the applications that were classified as rejected at step 410 may be adjusted to produce adjusted applications, which may correspond to the adjusted inputs in D′ produced as a result of adjusting the original applications, or original inputs. These three features may have been selected in any manner, such as through a dimensionality reduction algorithm that indicated these three features were the most pertinent to what classifications were assigned in step 410. The adjusted applications may then be provided to the classifier again at step 430, where the adjusted applications may be assigned a new approval or rejection classification. Consequently, because only the applications that were originally assigned a rejection classification were considered in step 420 in this particular example, some of the adjusted applications may be assigned an approval classification which contrasts with the rejection classification for the original applications they were produced from. However, some of the other adjusted applications may still be assigned a rejection classification despite the adjustments to the credit score, debt-to-income ratio, and income level.

Because the model that may be trained in this example may be designed to only support or require the adjusted applications that were approved, only information associated with those adjusted applications may be recorded into a training set at step 440. The resulting training set may have a similar structure as the example illustrated in FIG. 3. In such a training set, each of the m original inputs T₁ to Tₘ may be the original applications corresponding to the adjusted applications that were assigned approval classifications in step 430. The adjusted features column may include identifiers for the credit score, debt-to-income ratio, and income level as those were the features that were adjusted to produce the adjusted applications. The adjustment amounts that were made to each of those features may then also be recorded into the training set.

At step 450, a model may be trained using the training set comprising the original applications and adjustment information from the adjusted applications with approval classifications. In this specific example, the model being trained may be designed to take as the model's input an original application that was assigned a rejection classification and produce as the model output the features that are most pertinent to the original application being assigned a rejection classification and adjustments that may be made to those features that would produce a corresponding adjusted application that may be assigned an approval classification. In the example of FIG. 4, the trained model may identify that the debt-to-income ratio is the most pertinent feature in the original applications that were rejected, and may also identify the debt-to-income ratio that the original applications may need to achieve in order to be approved and consequently, what adjustments may need to be made to the debt-to-income ratio of the rejected original applications. That output identifying the debt-to-income ratio as the pertinent feature and adjustments to the debt-to-income ratio may be the descriptions for the rejection, or negative, classifications assigned to the original applications, or original inputs, and accordingly, enable the model to automatically generate descriptions for the classification results.

Particular examples may repeat one or more steps of the method of FIG. 1, where appropriate. Although this disclosure describes and illustrates particular steps of the method of FIG. 1 as occurring in a particular order, this disclosure contemplates any suitable steps of the method of FIG. 1 occurring in any suitable order. Moreover, although this disclosure describes and illustrates an example method for automatically generating descriptions for classification results including the particular steps of the method of FIG. 1, this disclosure contemplates any suitable method for automatically generating descriptions for classification results including any suitable steps, which may include all, some, or none of the steps of the method of FIG. 1, where appropriate. Furthermore, although this disclosure describes and illustrates particular components, devices, or systems carrying out particular steps of the method of FIG. 1, this disclosure contemplates any suitable combination of any suitable components, devices, or systems carrying out any suitable steps of the method of FIG. 1.

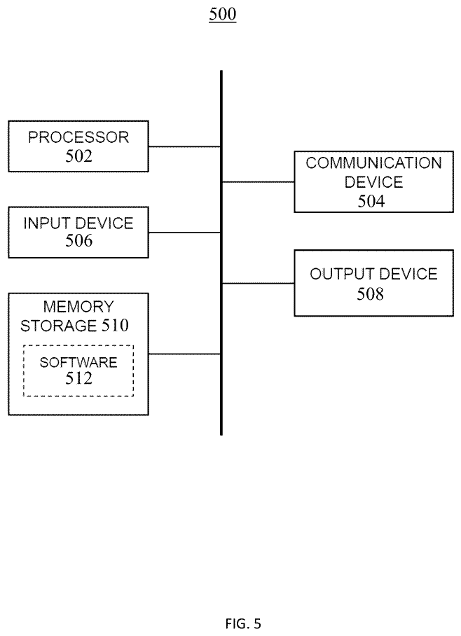

FIG. 5 depicts an exemplary computing device 500, in accordance with one or more examples of the disclosure. Device 500 can be a host computer connected to a network. Device 500 can be a client computer or a server. As shown in FIG. 5, device 500 can be any suitable type of microprocessor-based device, such as a personal computer, workstation, server, or handheld computing device (portable electronic device) such as a phone or tablet. The device can include, for example, one or more of processors 502, input device 506, output device 508, storage 510, and communication device 504. Input device 506 and output device 508 can generally correspond to those described above and can either be connectable or integrated with the computer.

Input device 506 can be any suitable device that provides input, such as a touch screen, keyboard or keypad, mouse, or voice-recognition device. Output device 508 can be any suitable device that provides output, such as a touch screen, haptics device, or speaker.

Storage 510 can be any suitable device that provides storage, such as an electrical, magnetic, or optical memory, including a RAM, cache, hard drive, or removable storage disk. Communication device 504 can include any suitable device capable of transmitting and receiving signals over a network, such as a network interface chip or device. The components of the computer can be connected in any suitable manner, such as via a physical bus or wirelessly.

Software 512, which can be stored in storage 510 and executed by processor 502, can include, for example, the programming that embodies the functionality of the present disclosure (e.g., as embodied in the devices as described above).

Software 512 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 510, that can contain or store programming for use by or in connection with an instruction execution system, apparatus, or device.

Software 512 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 500 can implement any operating system suitable for operating on the network. Software 512 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The examples disclosed above are only examples, and the scope of this disclosure is not limited to them. Particular examples may include all, some, or none of the components, elements, features, functions, operations, or steps of the examples disclosed above. Examples according to the disclosure are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the examples and features described or depicted herein can be claimed in a separate claim and/or in any combination with any example or feature described or depicted herein or with any of the features of the attached claims.

The scope of this disclosure encompasses all changes, substitutions, variations, alterations, and modifications to the example examples described or illustrated herein that a person having ordinary skill in the art would comprehend. The scope of this disclosure is not limited to the example examples described or illustrated herein. Moreover, although this disclosure describes and illustrates respective examples herein as including particular components, elements, feature, functions, operations, or steps, any of these examples may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular examples as providing particular advantages, particular examples may provide none, some, or all of these advantages.

1. A method for generating descriptions of classification results, comprising:
receiving a data set;
classifying a plurality of original inputs in the data set using a classifier, such that each of the plurality of original inputs is assigned a respective first classification;
for one or more of the plurality of original inputs:
applying an adjustment to one or more features of the original input to produce a respective adjusted input; and
classifying the respective adjusted input using the classifier, such that the respective adjusted input is assigned a respective second classification;
for one or more of the adjusted inputs:
recording a corresponding original input into a training set; and
recording information associated with the adjusted input into the training set, wherein the information indicates the adjustment to produce the adjusted input; and
training a model based on the training set, such that the model is configured to receive an original model input and identify a hypothetical adjustment that, if applied to the original model input, would produce an adjusted model input, wherein the adjusted model input would be assigned an adjusted model classification that indicates a different class than a class indicated by an original model classification assigned to the original model input.

2. The method of claim 1, wherein the information associated with the adjusted input comprises the one or more features for the adjusted input that were adjusted and one or more adjustment amounts that were applied to the one or more features.

3. The method of claim 1, wherein the respective second classification of the one or more of the adjusted inputs indicates a different class than an original class indicated by the respective first classification for the corresponding original input.

4. The method of claim 1, wherein the model is configured to receive the original model input and output the hypothetical adjustment.

5. The method of claim 1, wherein the model is configured to receive the original model input and the hypothetical adjustment, and output an indication as to whether the hypothetical adjustment would produce the adjusted model input.

6. The method of claim 1, wherein the hypothetical adjustment comprises one or more features of the original model input and one or more adjustment amounts for the one or more features of the original model input.

7. The method of claim 1, further comprising applying a second adjustment to the one or more features of the original input to produce a second adjusted input corresponding to the original input.

8. The method of claim 1, comprising selecting the one or more features that are adjusted based on a user input.

9. The method of claim 1, comprising selecting the one or more features that are adjusted based on a dimensionality reduction operation.

10. The method of claim 1, wherein the one or more features for one of the original inputs that are adjusted are different than the one or more features that are adjusted for at least one of the other original inputs.

11. The method of claim 1, comprising determining adjustment amounts for one or more of the adjusted features based on a user input.

12. The method of claim 1, comprising determining an adjustment amount for the adjustment to the one or more features for the original input based on a statistical characteristic of values for the feature in the original inputs in the data set.

13. One or more computer-readable non-transitory storage media embodying software for generating descriptions of classification results, the software comprising instructions operable when executed by a computing system to perform the method of claim 1.

14. The one or more computer-readable non-transitory storage media of claim 13, wherein the information associated with the adjusted input comprises the one or more features for the adjusted input that were adjusted and one or more adjustment amounts that were applied to the one or more features.

15. The one or more computer-readable non-transitory storage media of claim 13, wherein the respective second classification of the one or more of the adjusted inputs indicates a different class than an original class indicated by the respective first classification for the corresponding original input.

16. The one or more computer-readable non-transitory storage media of claim 13, wherein the model is configured to receive the original model input and output the hypothetical adjustment.

17. A system for generating descriptions of classification results, the system comprising one or more processors and a memory coupled to the processors comprising instructions executable by the processors, the processors being operable when executing the instructions to cause the system to perform the method of claim 1.

18. The system of claim 17, wherein the information associated with the adjusted input comprises the one or more features for the adjusted input that were adjusted and one or more adjustment amounts that were applied to the one or more features.

19. The system of claim 17, wherein the respective second classification of the one or more of the adjusted inputs indicates a different class than an original class indicated by the respective first classification for the corresponding original input.

20. The system of claim 17, wherein the model is configured to receive the original model input and output the hypothetical adjustment.
